(19) United States
(12) Patent Application Publication
(10) Pub. No.: US 2015/0062924 A1
(43) Pub. Date: Mar. 5, 2015

(54) MOUNTING BRACKET FOR A REFLECTOR

(71) Applicant: Douglas James Stroman, Brown City, MI (US)

(72) Inventor: Douglas James Stroman, Brown City, MI (US)

(21) Appl. No.: 14/011,576

(22) Filed: Aug. 27, 2013

(51) Int. Cl. F21V 7/00

(52) U.S. Cl. CPC F21V 7/00
USPC 362/341; 29/525.01

(57) ABSTRACT

A reflector bracket that may be mounted to a surface, such as a divider of a highway or a road. The reflector bracket may include a top surface and a bottom surface. The top surface may include raised portions that form a pocket. A reflector frame may include a wing portion and a reflector attached to the wing portion. The wing portion may be inserted into the pockets and thereby secured to the reflector bracket. Bolts may be used to secure the reflector bracket to the surface.

### BACKGROUND OF THE INVENTION

The present invention relates to a mounting bracket for a reflector and, more particularly, to a bracket that may be mounted to a surface and a reflector that may be attached to the bracket.

A raised pavement marker is a safety device used on roads. These devices are usually made with plastic, ceramic, or occasionally metal, and come in a variety of shapes and colors. Raised reflective markers include a lens or sheeting that enhances their visibility by reflecting automotive headlights. Reflectors are commonly used to delineate freeway traffic when they are placed on concrete barrier walls and bridge walls. The plastic reflectors are typically attached with adhesives. The adhesives are exposed to the elements of nature, including freezing temperatures, deicing substances, and rain. The exposure causes most of the adhesives to degrade. Further, the concrete walls and surfaces must be free of all dirt, concrete curing compound, and moisture in order for most adhesives to create a solid bond.

As can be seen, there is a need for a reflector that may be mounted to a surface mechanically.

### SUMMARY OF THE INVENTION

In one aspect of the present invention, a reflector mounting device comprises: a reflector frame comprising a wing portion, and a reflector connected to the wing portion; a reflector bracket comprising a top surface and a bottom surface, wherein the top surface comprises a raised portion forming a pocket formed to receive and secure the wing portion of the reflector frame; and at least one bolt configured to secure the reflector bracket to a surface.

In another aspect of the present invention, a method of mounting reflectors to a surface comprises: providing a reflector bracket comprising a top surface and a bottom surface, wherein the top surface comprises a raised portion forming a pocket; mounting the reflector bracket to a surface using at least one bolt; providing a reflector frame comprising a wing portion, and a reflector substantially perpendicular to the wing portion; and sliding the wing portion into the pocket and thereby securing the reflector frame to the reflector bracket.

These and other features, aspects and advantages of the present invention will become better understood with reference to the following drawings, description and claims.

### BRIEF DESCRIPTION OF THE DRAWINGS

FIG. 1 is a front perspective view of the present invention in use;

FIG. 2 is a detail front perspective view indicated by line 2-2 of FIG. 1;

FIG. 3 is an exploded perspective view of the present invention;

FIG. 4 is a front perspective view of the present invention;

FIG. 5 is a rear perspective view of the present invention;

FIG. 6 is a cross-sectional view taken on line 6-6 of FIG. 2; and

FIG. 7 is a detail cross-sectional view indicated by line 7-7 of FIG. 6.

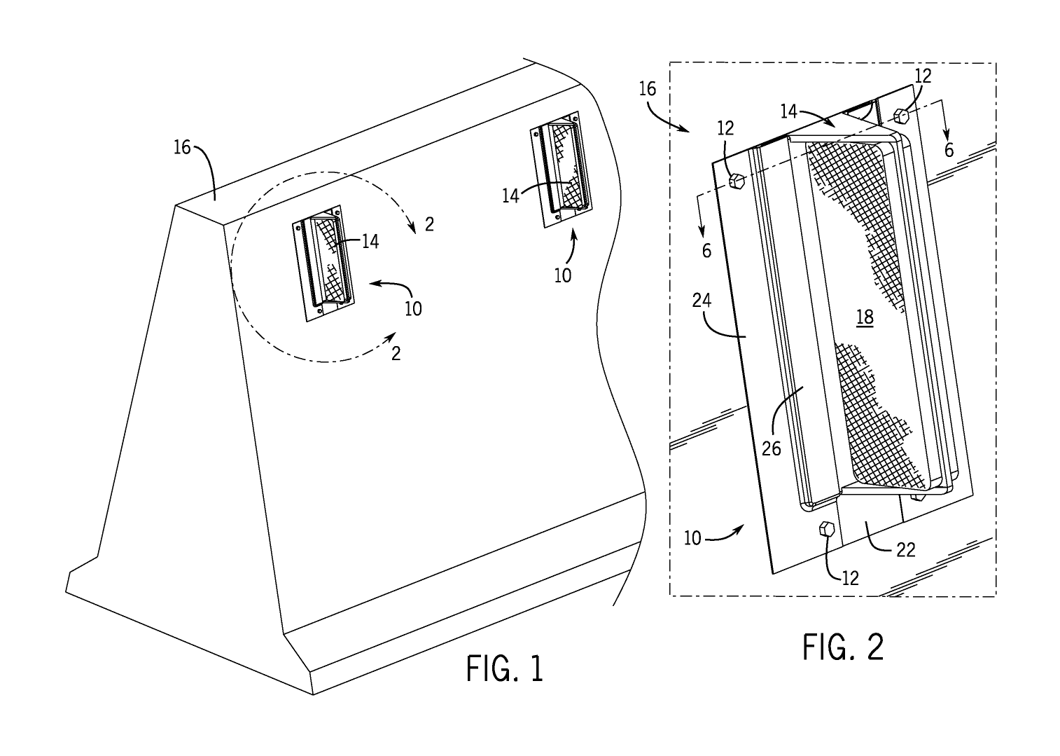

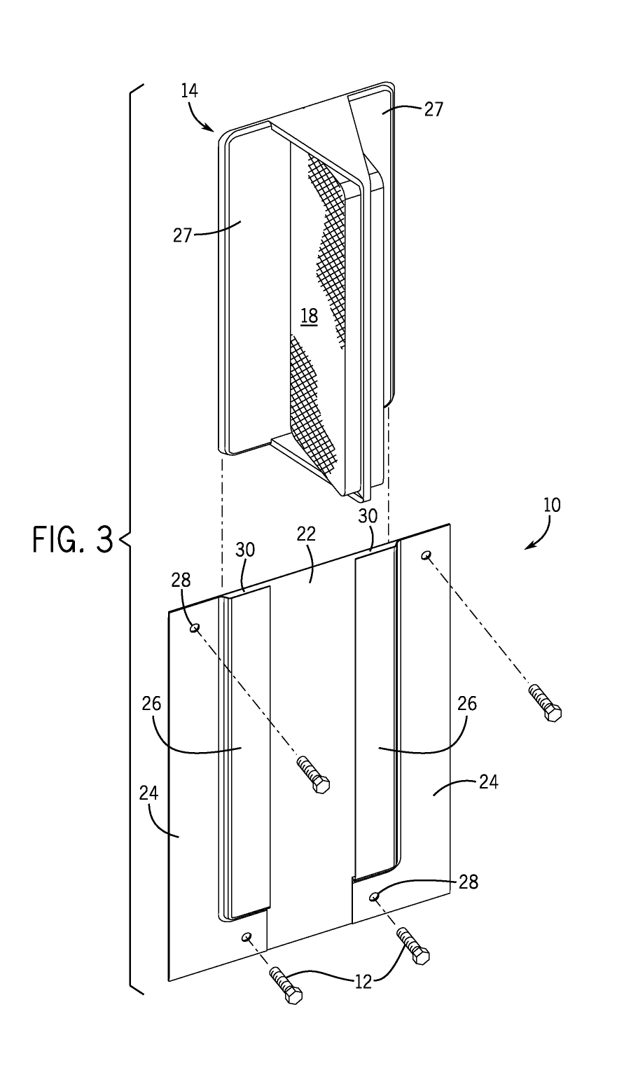

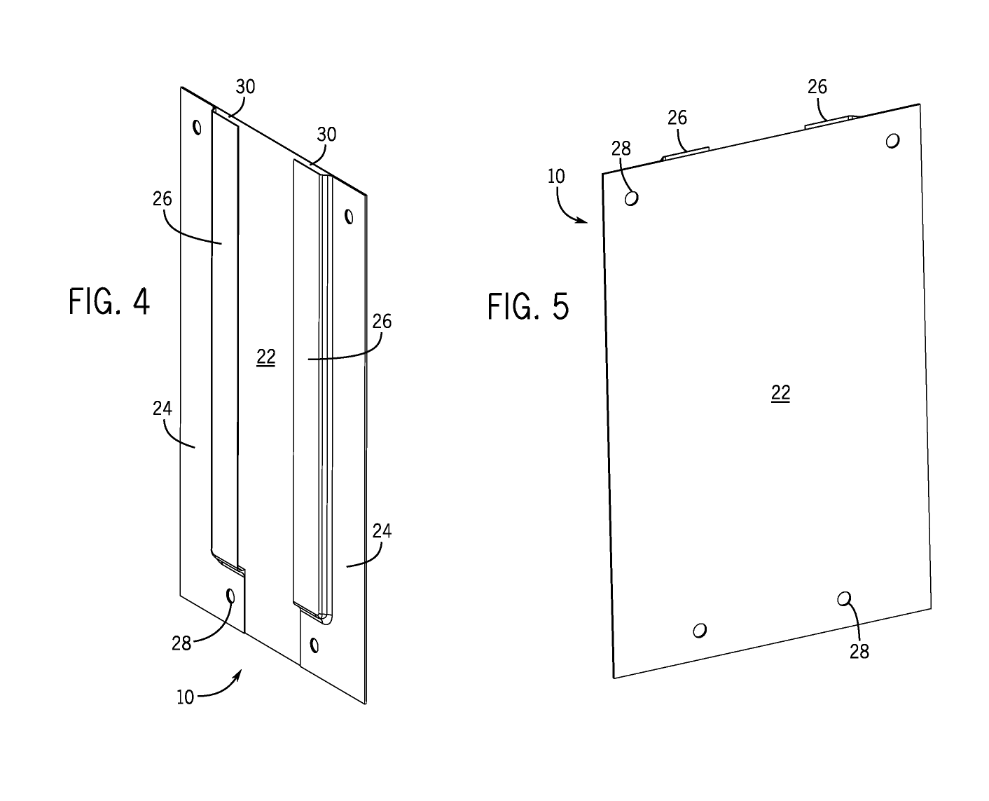

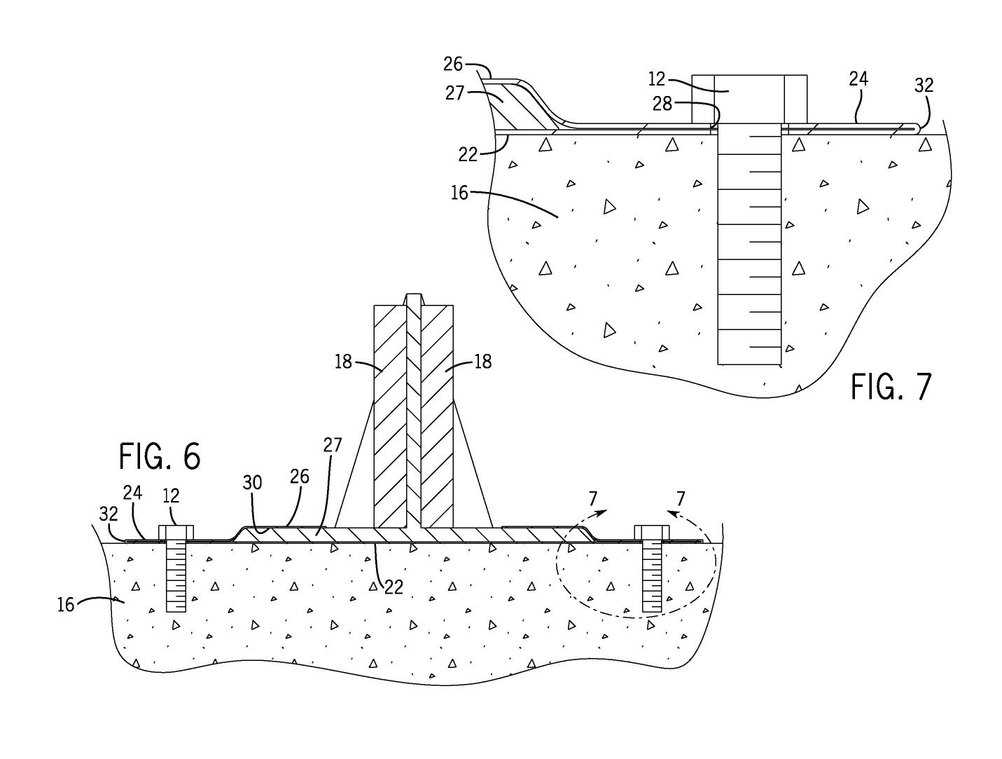

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a reflector bracket that may be mounted to a surface, such as a divider of a highway or a road. The reflector bracket may include a top surface and a bottom surface. The top surface may include raised portions that form a pocket. A reflector frame may include a wing portion and a reflector attached to the wing portion. The wing portion may be inserted into the pocket and thereby secured to the reflector bracket. Bolts may be used to secure the reflector bracket to the surface.

The present invention may include brackets to fasten reflectors in place. The present invention may include a reflector bracket that may be designed to attach to a wall surface using bolts, such as concrete nails or screws. A plastic reflector may be slid into the reflector clip, resulting in a solid and adhesive free connection to the wall. The present invention provides for a stronger connection, and does not degrade from the elements of nature.

Referring to the Figures, the present invention may include a reflector bracket 10 and a reflector frame 14. The reflector frame 14 may include a wing portion 27 and a reflector 18. The reflector 18 may be mounted to the wing portion 27 and may be substantially perpendicular to the wing portion 27. The reflector bracket 10 may include a top surface 24 and a bottom surface 22. The top surface 24 may have a raised portion 26 that forms a pocket 30. The pocket 30 may receive and secure the wing portion 27 of the reflector frame 14. At least one bolt 12 may be used to secure the reflector bracket 10 to a surface 16.

In certain embodiments, the wing portion 27 of the reflector frame 14 may include a first wing 27 and a second wing 27. In such embodiments, the raised portion 26 may include a first raised portion 26 and a second raised portion 26. The first raised portion 26 forms a first pocket 30 to receive and secure the first wing 27 and the second raised portion 26 forms a second pocket 30 formed to receive and secure the second wing 27. In certain embodiments, the pockets 30 may include an open end and a closed end, so that the wings may slide into the pockets 30 and rest against the closed end.

In certain embodiments, the reflector bracket 10 may be a sheet made out of metal or plastic. To form the top surface 24, the sheet may be folded over at bends 32. The ends of the top surface 24 may be raised relative to the bottom surface 22 and may thereby form the pockets 30. In certain embodiments, mounting holes 28 may run through the top surface 24 and the bottom surface 22. Bolts 12 may be formed to fit through the mounting holes 28 so that the reflector bracket 10 may be bolted to a surface 16, such as a barrier or road.

A method of mounting reflectors to a surface may include the following. A reflector bracket which may include a top surface and a bottom surface may be provided. The top surface may include a raised portion forming a pocket. The reflector bracket may be mounted to the surface using at least one bolt. A reflector frame having a wing portion, and a reflector substantially perpendicular to the wing portion may be provided. The wing portion may be slid into the pocket, thereby securing the reflector frame to the reflector bracket.

In certain embodiments, the present invention may be mounted by the following method. Once the desired location is determined the reflector bracket may be held in place while a pneumatic gun with the appropriate anchors, or a rotary drill is positioned in three or four locations around the two sides and the bottom. In each location the chosen anchor may go through the mounting holes and into the wall.

It should be understood, of course, that the foregoing relates to exemplary embodiments of the invention and that modifications may be made without departing from the spirit and scope of the invention as set forth in the following claims.

What is claimed is:

1. A reflector mounting device comprising:
a reflector frame comprising a wing portion, and a reflector connected to the wing portion;
a reflector bracket comprising a top surface and a bottom surface, wherein the top surface comprises a raised portion forming a pocket formed to receive and secure the wing portion of the reflector frame; and
at least one bolt configured to secure the reflector bracket to a surface.

2. The reflector mounting device of claim 1, wherein the wing portion comprises a first wing and a second wing.

3. The reflector mounting device of claim 2, wherein the raised portion comprises a first raised portion and a second raised portion, wherein the first raised portion forms a first pocket to receive and secure the first wing and the second raised portion forms a second pocket formed to receive and secure the second wing.

4. The reflector mounting device of claim 1, wherein top surface and the bottom surface meet at a first bend and a second bend.

5. The reflector mounting device of claim 1, wherein mounting holes are formed through the top surface and the bottom surface, wherein the at least one bolt is formed to fit through the mounting holes.

6. The reflector mounting device of claim 1, wherein the pocket comprises an open end and a closed end.

7. The reflector mounting device of claim 1, wherein the reflector substantially perpendicular to the wing portion.

8. A method of mounting reflectors to a surface comprising:
providing a reflector bracket comprising a top surface and a bottom surface, wherein the top surface comprises a raised portion forming a pocket;
mounting the reflector bracket to a surface using at least one bolt;
providing a reflector frame comprising a wing portion, and a reflector substantially perpendicular to the wing portion; and
sliding the wing portion into the pocket and thereby securing the reflector frame to the reflector bracket.
